(19) United States
(12) Patent Application Publication
(10) Pub. No.: US 2025/0330026 A1
(43) Pub. Date: Oct. 23, 2025

(54) VARIABLE LOAD CONTINUOUSLY SYNCHRONIZED ENGINE/GENERATORS WITH ENERGY STORAGE FOR LARGE AND DYNAMIC LOADS

(71) Applicant: Kevin R. WILLIAMS, Waller, TX (US)

(72) Inventor: Kevin R. WILLIAMS, Waller, TX (US)

(21) Appl. No.: 18/782,951

(22) Filed: Jul. 24, 2024

Related U.S. Application Data
(60) Provisional application No. 63/636,558, filed on Apr. 19, 2024.

(51) Int. Cl. H02J 3/46; E21B 41/00; F02D 29/06

(52) U.S. Cl. CPC H02J 3/46; F02D 29/06; E21B 41/00

(57) ABSTRACT

A power management system in which multiple engine/generators each has an output line adapted to supply AC power to a load. An AC bus is connected to an output of each of the multiple engine/generators. A controller is electrically connected to regulate power supplied to the AC bus. The multiple engine/generators are synchronous at full speed. The load of each of the multiple engine/generators can be rapidly varied between 0% and 100%. The controller is adapted to activate or deactivate at least one of the multiple engine/generators relative to the load. Through this novel control, the operation of the multiple engine/generators is more efficient so as to reduce fuel use and emissions output while more effectively meeting the load demand of the application.

### CROSS-REFERENCE TO RELATED APPLICATIONS

The present application claims priority from U.S. Provisional Application Ser. No. 63/636,558, Filed on Apr. 19, 2024.

### BACKGROUND OF THE INVENTION

The present invention relates to energy power management systems for supplying power to loads, such as drilling rigs, mining machines, dredges, etc. More particularly, the present invention relates to systems for optimizing the power output from engine/generators so as to supply power with minimal emissions and minimal fuel use.

In various applications, large dynamic loads are placed upon an electrical power system. These large dynamic loads can be from oil and gas drilling operations, from dredging operations, mining operations and from similar applications. During these operations, a large amount of power is required intermittently for the carrying out of the operation. For example, the power requirements used on the drilling rig serve to supply the drawworks, the mud pumps, top drives, the rotary tables, and other peripheral loads. As a result, power systems are often oversized to meet the “peak” power requirements.

Historically, the number of engine/generators that are used and are typically “online” are more than the required load of the operation due to the redundancy and necessary peak KW and VAR demand during certain aspects of the operation. In particular, these peak demands will occur during the “tripping” of the pipe or drill stem, during the drilling operation, during the picking of a bucket of material for dredging or mining operation, or similarly for other intermittent high loads for other applications.

For drilling operations there is a base load of lighting, pumps, agitators, mixers, air compressors, etc. This base load can make up typical loads of 400 to 600 kilowatts. The mud pumps, top drives or rotary tables contribute another fairly consistent kilowatt-levels demand. This demand will vary based on the particular well, depth of drilling, and material being drilled.

During oil well drilling activities, the most intermittent load is the drawworks. This intermittent load is directed toward the peak demand during raising and lowering of the drill pipe upwardly and downwardly in the well. This peak demand can have loads as much as two to four 20times the base loads of other demands on the drilling rig.

When drilling at times when the downhole tool has to be inspected or changed, it is required to pull the length of the drill pipe from the hole being drilled. This distance can be 10,000 feet or more. The drill pipe must be taken apart and stacked as it is being removed. After repair or replacement, the reverse procedure must take place so as to reinsert all the components back to the desired depth. During the tripping in or out of the hole, the driller (operator) demands extreme power consumption and very quick bursts as the driller raises (or lowers) the string of drill pipe. Since there is a limitation on the height of the drilling mast, the operator must lift the section in increments and unscrew the different sections. The sections are stacked one at a time. This process is repeated during the re-insertion of the drill pipe back into the hole. This process is referred to as “making a trip”. The intermittent high demand occurs when this resulting force (20,000 to 1,000,000 pounds) is repeated over and over again. The load rapidly changes since the weight of the drill stem becomes less as sections are removed or more if tripping back into the hole. The base load requirements for land drilling operations are approximately 400-600 kilowatts. The peak demand can be 1.5 megawatts and as high as 3.0 megawatts for offshore operations. Because of these dynamic power requirements, the emissions of the engine/generators for a typical land rig can be quite high as well as result in poor fuel efficiency. There are also large amounts of carbon dioxide emissions. The fuel consumption during these intermittent demands can be quite significant.

Rigs operate excess engine/generators to mitigate variable loads encountered during the drilling process. As an example, for the case where the rig would operate with four engine/generators continuously, energy storage systems can now allow the drilling operations to operate with one or two engine/generators instead of four. As drilling demand load changes, engine/generators switch on-and-off as required. The need for excess engine/generators is unnecessary with an energy storage system (“ESS”) that provides high-power and “peak shaving control” due to hoisting operations. The hoisting entails high intermittent power demands even when drilling ahead and not necessarily “tripping”. To maximize rig efficiency, the need for power management in which engine/generators are brought online/offline based on the load demand is also necessary. Even then, there are many times in which the demand requires multiple engine/generators online but, due to the total demand, the engines are equally load sharing and are not operating necessarily in their most efficient spot, such as being too lightly loaded.

Energy storage systems provide supplemental power that permit any intermittent high power demand to be supplemented by energy storage. As such, the high intermittent loads from the online engine/generators is not demanded. The recovery of the braking energy from many of these applications (such as the drawworks) on a drilling rig is also captured and used by the energy storage system in lieu of burning the energy in a manner that is carried out on present drilling rigs. Transition times or step load changes take longer for natural gas engine/generators due to their limited dKW/dT for step-up and step-down power changes. This also can be enhanced by the assistance of energy storage. With energy storage for peak-shaving, the operation of the application where high load demands are realized is enhanced and the operation has greatly improved efficiency.

Energy storage systems that provide peak shaving typically have a storage capacity of over 500 kWh for chemical battery systems. Less capacity is required for capacitor or flywheel systems. Chemical batteries are better suited for higher energy and lower power applications.

In typical drilling operations, and other operations having variable high-power demands, there are long extended periods of time when the power requirements of the engine/generator are relatively low. This can be, for example, when the drilling rig operation is shut down, but hotel loads at the drilling operation continue. When the drilling rig operation is being started, pipe is being moved and other energy consuming activities occur. This will add to the hotel load over another extended period of time. Once the drilling operations are in full force, the power requirements will be much greater over an extended period of time. Peak shaving of the electrical power demand is very effective for intermittent variations in power requirements, but does not address the application's variable power consumption over a longer period of time and its effect on reducing operating efficiency of the engine/generators.

In the past, various patents and patent publications have issued with respect to power usage and the control of such power usage by drilling rig systems. However, none of these provide a novel load control for the engine/generators which purposefully provide constant speed and variable load control so as result in improved fuel efficiency with lower emissions.

For example, U.S. Pat. No. 4,590,416, issued on May 20, 1986, to Porche et al., teaches a closed loop power factor control for power supply systems. This power factor controller for alternating current/direct current drilling rigs. The power factor controller utilizes a uniquely controlled, unloaded, over-excited generator to reactive power to maintain the rig's power factor within prescribed limits during peak demand operations. In particular, this method includes the step of: (1) sensing the instantaneous system power factors; (2) comparing the sensed instantaneous power factor to a prescribed power factor; (3) forming a power factor control signal indicative of the difference between the sensed power factor and the prescribed power factor; (4) providing a field excitation signal to an unloaded over-excited generator operated in the motor mode in proportion to the power factor control signal so as to cause the over-excited generator to generate the requisite reactive power to correct the system's power factor to the prescribed power factor; and (5) coupling the output of the over-excited generator to the power system.

U.S. Patent Publication No. 2008/0203734, published on Aug. 28, 2008 to Grimes et al., describes a wellbore rig generator engine power control system. This system controls power load to a rig engine. This system includes a sensor for controlling a rig engine and a sensor for sensing the exhaust temperature of a rig engine. The sensor is in communication with the controller so as so as to provide the controller with signals indicative of the exhaust temperature. The controller maintains power load to the rig engine based on the exhaust temperature.

U.S. Patent Publication No. 2009/0195074, published on Aug. 6, 2009 to Buiel, shows an energy supply and storage system for use in combination with a rig power supply system. This system includes a generator start/stop and a power output control. A bi-directional AC/DC converter converts the AC power generated by the engine-generator. The power supply is adapted to draw energy from the storage system when the rig motor exceeds the capacity of the generator.

U.S. Patent Publication No. 2009/0312885, published on Dec. 17, 2009 to Buiel, teaches a management system for drilling rig power supply and storage. This management system has a power generator coupled to rig loads. The power generator is used for powering and charging the storage system. The energy storage system draws energy from the storage system in periods of high-power requirements and distributes excess energy to the storage system in periods of lower power requirements. The output of the power generator is managed based on the rig power usage wherein the output is increased when the rig power requirements are above a preselected threshold and wherein the output is decreased when the rig power requirements fall below a preselected threshold.

One of the problems of the Buiel applications is that the power generator supplements and complements the power requirements of the load in order to satisfy the rig power demand. As such, when rig power demand is high, the generators will operate with relatively high dynamic loads. The operation of the engine/generator can vary significantly between low operating requirements and high operating requirements. As such, the generators are unable to achieve a near steady-state power output level. This reduces the fuel efficiency and economy, and increases the emissions from such generators. As such, the Buiel publications fail to allow the engine/generator to operate in a generally steady-state power output level.

U.S. Patent Publication No. 2011/0074165, published on Mar. 31, 2011 to Grimes et al., describes a system for controlling power load to a rig engine of a wellbore rig. The system includes a controller for controlling the rig engine and a sensor for sensing the exhaust temperature of the rig engine. The sensor is in communication with the controller for providing to the controller signals indicative of the exhaust temperature. The controller maintains the power load to the rig engine based on the exhaust temperature.

The Grimes publication also uses the engine/generator to complement or supplement the load requirements. As such, when the battery levels are low, additional power is transferred directly from the engine/generator to the load. The engine/generator will have to respond to high dynamic loads and low dynamic loads. As such, the engine/generator will be unable to operate in near steady-state conditions. This creates inefficiencies and unreliability. It also reduces fuel economy and increases emissions.

The present inventor has various patents and patent application publications relating to energy storage and peak-shaving of energy power demands. For example, U.S. Pat. No. 7,633,248, issued on Dec. 15, 2009 to the present inventor, describes a system for managing energy consumption in a heave-compensating drawworks. The system includes a power supply, a winch drum connected to the power supply so as to receive power from the power supply, a flywheel connected to the winch drum and to the power supply, and a controller connected to the power supply and to the winch drum for passing energy to and from the flywheel during an operation of the winch drum. The flywheel includes a disk rotatably coupled to an AC motor. The power supply includes a first pair of AC motors operatively connected on one side of the winch drum and a second pair of AC motors operatively connected on an opposite side of the winch drum.

U.S. Pat. No. 8,446,037, issued on May 21, 2013 to the present inventor, describes an energy storage system for a drilling rig that has a source of power, an AC bus connected to the source of power, a DC bus, a load connected to the DC bus, a rectifier connected to the AC bus and to the DC bus for converting AC power from the source of power to DC power to the load, and an energy storage system connected to the DC bus. The energy storage system can be batteries, capacitors or combinations thereof. A diode is connected between the energy storage system and the DC bus so as to supply power to the load when the DC voltage is less than the DC source voltage. The energy storage system has a nominal voltage slightly lower than the voltage of the AC-to-DC conversion by the rectifier.

U.S. Pat. No. 9,059,587, issued on Jun. 16, 2015 to the present inventor, teaches a system for providing power to a load of the drilling rig that has natural gas engine/generators and an energy storage system. The load is switchable to one or both of the natural gas engine/generators and the energy storage system. The natural gas engine/generators and the energy storage system have a capacity suitable for supplying requisite power to the load. A rectifier is connected to an output line of the engine/generators so as to convert the AC power to DC power. This rectifier is a phase-controlled silicon-controlled rectifier so as to be responsive to a power requirement of the load. The energy storage system is a battery.

U.S. Pat. No. 9,065,300, issued on Jun. 23, 2015 to the present inventor, describes a system for providing power to a load of a drilling rig that has a dual fuel engine/generator and an energy storage system. The load is switchable to one or both of the dual fuel engine/generators and the energy storage system. The dual fuel engine/generators and the energy storage system have a capacity suitable for supplying requisite power to the load. A rectifier is connected to an output line of the engine/generators so as to convert the AC power to DC power. The energy storage system is a battery.

U.S. Pat. No. 9,197,071, issued on Nov. 24, 2015 to the present inventor, provides a system for supplying power to a drilling rig and has an engine/generator with an output line that transfers power therefrom, an energy storage system connected to the engine/generators, and a load connecting the engine/generator to the energy storage system such that the power from the energy storage system is directly transferred to the load and such that power from the engine/generator is electrically isolated from the load. The engine/generator has a capacity greater than a maximum power requirement of the load. The energy storage system can include at least one battery.

U.S. Patent Application No. 2023/0205146, published on Jun. 29, 2023 to the present inventor, shows a method for managing a power system that includes energizing an alternating current bus via one or more generators, rectifying energy from the AC bus to power a direct current bus, powering one or more loads electrically connected to the DC bus, monitoring a DC voltage of the DC bus, detecting a magnitude and a rate of change of the DC voltage or AC frequency from a predetermined value, and transferring an amount of power from the DC bus or the AC bus. An energy storage system is electrically coupled to the buses to return the DC voltage or AC frequency substantially to the predetermined value. The amount of power is based on the magnitude and rate of change.

It is an object of the present invention to provide a system that has the ability to vary a load among an online set of synchronized engine/generators.

It is another object of the present invention to provide a system that optimizes fuel economy.

It is another object of the present invention to provide a system that reduces emissions.

It is another object of the present invention to reduce the size of the required energy storage.

It is another object of the present invention to provide a system that lowers energy storage costs.

It is another object of the present invention provide a system that eliminates the need for specialized engine systems that maintain oil temperature and internal lubrication between start-ups.

It is another object of the present invention to provide a system that keeps multiple engines continuously operating.

It is another object of the present invention to provide a system that avoids large engine load transits.

It is still another object of the present invention provide a system that avoids operating conditions that reduce engine life due to rapid starts and intermittent high load demands.

It is a further object of the present invention to provide a system that rapidly adds power with low transition times.

It is still a further object of the present invention to provide a system wherein the engine/generators share loads equally based on a total load of the system.

It is still a further object of the present invention provide a system that avoids blackout conditions.

These and other objects and advantages of the present invention will become apparent from a reading of the attached specification and appended claims.

### SUMMARY OF THE INVENTION

The present invention is a power management system that comprises multiple engine/generators having an output line adapted to supply AC power to a load and a controller electrically connected to an AC bus and connected to the multiple engine/generators. The multiple engine/generators are synchronous. The controller is adapted to activate or deactivate at least one or all of the multiple engine/generators relative to the load. The controller is adapted to vary the load of each of the multiple engine/generators to between 0% and 100% of a nameplate rating.

All of the multiple engine/generators operate at a constant speed and in-phase with each other. A sensor is connected to the load. The sensor provides an input to the controller of the amount of the load. In particular, the sensor can detect a fluid flow rate of the load. A load point of each of the engine/generators is independently variable in relation to the load.

Each of the multiple engine/generators has a nameplate rating. The controller sets a power output to 0% to 100% of the nameplate rating. The engine/generators can have a level of maximum fuel efficiency which lies between 0% and 100% of the nameplate rating. The controller adjusts the multiple engine/generators to the level of maximum fuel efficiency. The multiple engine/generators are electrically connected in parallel to the AC bus. The nameplate rating has a level of minimum emissions output which lies between 0% to 100% of the operating load point. The controller adjusts the multiple engine/generators to this level of minimum emissions output.

A first circuit breaker is connected between at least one of the multiple engine/generators and the AC bus. A second circuit breaker is connected between another of the multiple engine/generators and the AC bus, and so forth for all engine/generators. The controller is adapted to open or close the circuit breakers relative to the load. The controller varies a power output of the multiple engine/generators so as to collectively meet a demand of the load.

An energy storage system is connected to the load. This energy storage system is adapted to supply or to store power to and from the load. Each of the multiple engine/generators is selected from the group consisting of a gasoline engine/generator, a natural gas engine/generator, a dual fuel engine/generator, a diesel engine/generator, a flare gas engine/generator and a gas turbine. In the preferred embodiment of the present invention, the load is a drilling rig operation using diesel engine/generators.

The present invention is also a process for managing power to a load. For example, this process can comprise the steps of: (1) connecting a first engine/generator and a second engine/generator to the load; (2) synchronizing the first engine/generator with the second engine/generator; (3) measuring a power demand of the load; (4) connecting or disconnecting one of the first engine/generator and the second engine/generator relative to the measured power demand of the load.

Each of the first engine/generator or the second engine/generator (or either of the multiple engine/generators) are run independently at 0% to 100% of the nameplate power rating. The nameplate rating has a level of optimum fuel efficiency and a minimum level of emissions output at between 0% to 100% of the nameplate rating. The step of running includes running each of the engine/generators at the level of optimum fuel efficiency and minimum emissions output. At least one of the first engine/generator and the second engine/generator is connected or disconnected relative to the measured power demand of the load. In particular, the step of connecting or disconnecting comprises opening or closing a circuit breaker on a line between an AC bus and each of the engine/generators.

This foregoing Section is intended to describe, with particularity, the preferred embodiments of the present invention. It is understood that modifications to this preferred embodiment can be made within the scope of the present claims. As such, this Section should not to be construed, in any way, as limiting of the broad scope of the present invention. The present invention should only be limited by the following claims and their legal equivalents.

### BRIEF DESCRIPTION OF DRAWINGS

FIG. 1 is a schematic showing of the energy system for drilling rigs of the prior art.

FIG. 2 is a schematic illustration of an energy system for a drilling rig which incorporates peak shaving.

FIG. 3 is a diagrammatic illustration of the system of the present invention.

FIG. 4 is a graph representing the load versus time during a drilling rig operation.

### DETAILED DESCRIPTION OF THE INVENTION

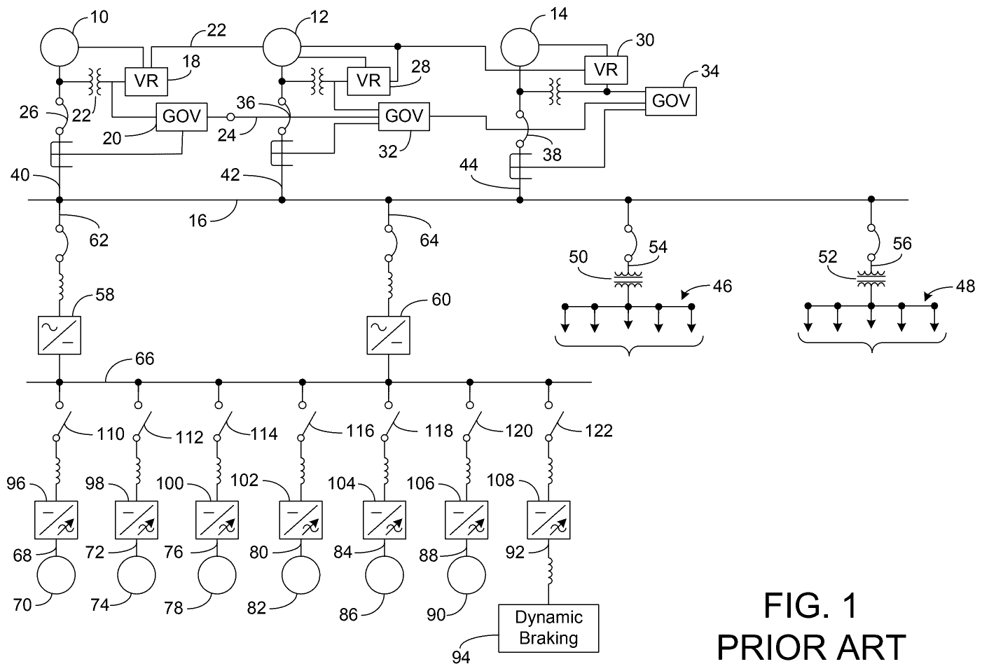

FIG. 1 illustrates a schematic of a prior art drilling rig topology utilizing a common DC bus system. As can be seen in FIG. 1, the AC synchronous engine/generators 10, 12 and 14 are synchronized to an AC bus 16. The AC bus 16 is synchronized onto a common AC fixed frequency/fixed voltage system from which peripheral loads, such as hotel loads, are supplied. The engine/generator 10 is connected to a voltage regulator 18 and to a governor 20. A potential transformer 22 is positioned between the voltage regulator 18 and the engine/generator 10. A cross current line 22 will extend from the voltage regulator 18 to the engine/generator 12. A load sharing line 24 is connected to the governor of the various engine/generators. A circuit breaker 26 is positioned between the engine/generators 10 and the common AC bus 16.

The engine/generator 12 and the engine/generator 14 also include respective voltage regulators 28 and 30 and governors 32 and 34. Engine/generators 12 and 14 also have respective circuit breakers 36 and 38. Lines 40, 42 and 44 connect the engine/generators 10, 12 and 14 to the AC bus 16. Motor control centers 46 and 48 have power transformers 50 and 52 respectively connected along lines 54 and 56 to the AC bus 16. Rectifiers 58 and 60 are placed on respective lines 62 and 64 so as to convert the AC power along bus 16 into DC power. Lines 62 and 64 are, in turn, connected to the common DC bus 66.

The common DC bus feeds multiple inverters for each of the rig functions. Line 68 is connected to a drawworks motor 70. Line 72 is connected to another drawworks motor 74. Line 76 is connected to a first mud pump 82. Line 84 is connected to a top drive 86. Line 88 is connected to the rotary table 90. Another line 92 serves to connect the DC bus to a dynamic braking system 94. Each of the lines 68, 72, 76, 80, 84, 88 and 92 have a respective DC-to-AC variable frequency/variable voltage converters 96, 98, 100, 102, 104, 106 and 108. Each of the lines 68, 72, 76, 80, 84, 88 and 92 also has respective switches 110, 112, 114, 116, 118, 120 and 122 connected together. The switches are DC disconnect switches.

As can be seen in FIG. 1, the power requirements of the various motors 70, 74, 78, 82, 86, 90 and 94 must be supplied by the engine/generators 10, 12 and 14. In view of the “peak” requirements of the drawworks motor 70 and 74, the engine/generators 10, 12 and 14 will need to be oversized so as to meet the power requirements. In other circumstances, additional engine/generators must be connected to the AC bus 16 in order to supply the requisite power to the various motors associated with the drilling rig.

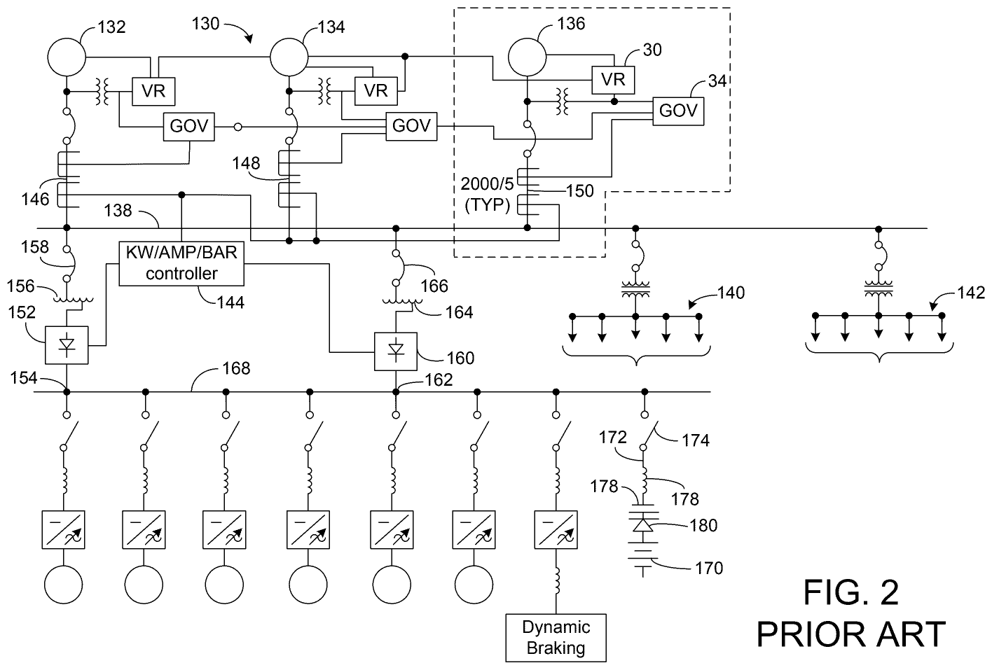

FIG. 2 shows a system for the peak shaving of intermittent loads of the energy system of the prior art. The energy system 130, as illustrated in FIG. 2, is used in association with the various energy-consuming components of a drilling rig. In FIG. 2, it can be seen that the engine/generators 132, 134 and 136 are used to generate the power requirements for the system 130. The engine/generator 136 is optional based upon the power requirements of the system 130. The system 130 could only require the power output from the engine/generators 132 and 134. The various voltage regulators and governors are connected to the engine/generators 132, 134 and 136 in the manner described herein previously in association with FIG. 1. Each of the engine/generators 132, 134 and 136 is connected to the AC bus 138. The motor control centers 140 and 142 are connected to the AC bus 138 in the manner described herein previously.

There is a KW/AMP/VAR controller 144 that is joined to each of the lines 146, 148 and 150 associated with the engine/generators 132, 134 and 136. An autotransformer 156 is connected to line 154. A circuit breaker 158 is formed on line 154. The KW/AMP/VAR controller 144 is connected by a line to the SCR-controlled rectifier 152. This KW/AMP/VAR controller 144 is also connected to a second SCR-controlled rectifier 160. The SCR-controlled rectifier 160 is connected to line 162. Line 162 also includes another autotransformer 164 and a circuit breaker 166. Lines 154 and 162 are connected to the common DC bus 168.

The various energy-consuming components of the drilling rig of the system 130 are connected to the common DC bus 168 in a manner described in association with FIG. 1 hereinbefore. The DC bus 168 is connected to the energy storage system 170 by line 172. Line 172 has a DC disconnect switch 174 thereon. A DC connector 178 is on line 172. The blocking diode 180 serves to connect the energy source in the energy storage 170 with line 172. The energy storage 170 can be in the nature of flywheels, lead-acid batteries, ultra-capacitors, lithium titanate batteries, or paralleled-series connections of batteries and capacitors.

A unique feature of this system is to diode 4 the energy storage system 170 to the common DC bus 168. There will always be a nominal voltage from this DC storage 170 slightly lower than the rectified AC-to-DC conversion from the SCR phase-controlled bridge rectifiers 152 and 160. When utilizing the SCR controller with the standard engine/generator voltages, the autotransformers 156 and 164 are implemented for a twelve-pulse converter which is approximately 10% higher, once rectified at full conduction angle in phase-controlling SCR controllers 152 and 160 and by using the current feedback from the main engine/generators 132, 134 and 136 so as to conduct back this AC-to-DC voltage once the threshold of current (full load current or selectable current limit) is reached. Once this DC source voltage from the engine/generators 132, 134 and 136 is achieved, the energy storage 170 will supply the necessary excess power that the engine/generators 132, 134 and 136 cannot supply due to power limitations.

The system 130 is practical, low-cost, inherently stable and reliable. The redundancy of having the DC stored energy directly tied to the common DC link with passive devices is important to safety issues with well control and circulation of drilling mud and drawworks control. As such, power can continue to be supplied even in the event of loss of AC power from any of the engine/generators 132, 134 and 136.

It should be noted that the system shown in FIG. 2 is directly applicable and useful for avoiding peak loads from the drilling system. These peak loads are relatively instantaneous loads that can occur during the tripping of the drill pipe or otherwise occur in short bursts. However, this system is not directly applicable under those circumstances where there is a change of load over extended periods of time. FIG. 4 is an illustration of how these loads can change over extended periods of times (such as many days). In particular, when the system 130 is employed, the graph of FIG. 4 shows that there are no “instantaneous” peaks that require further peak shaving. Initially, in line 200, the engine/generators supply a hotel load for the drilling rig operation. This hotel load for the drilling rig operation can be under those circumstances where no drilling is actually occurring or where initial set up of the drilling location is occurring. As such, these hotel loads shown by line 200 will simply be lighting and air-conditioning for the workers, along with other minor electrical requirements.

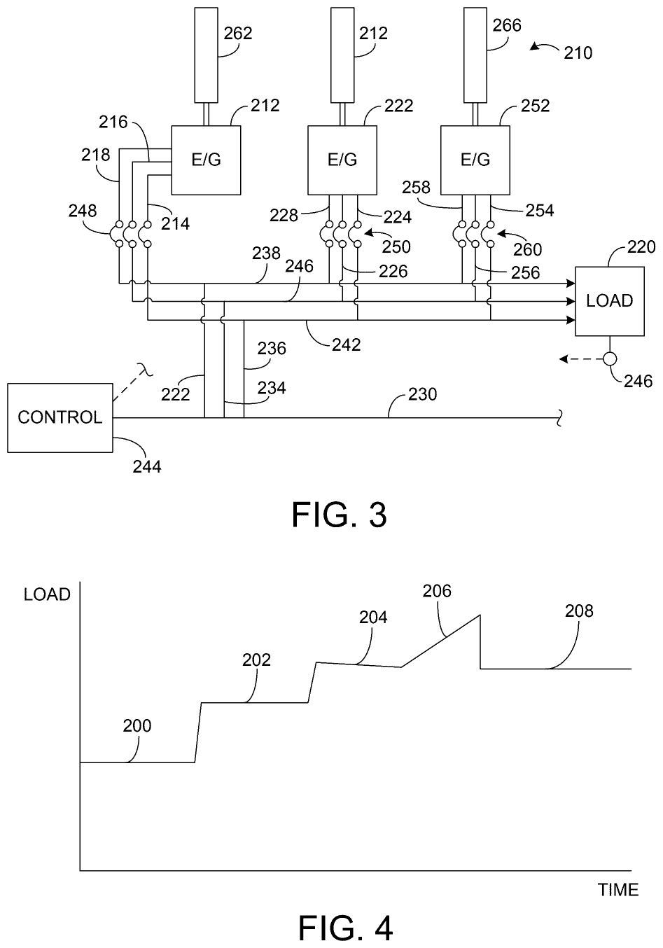

After a certain period of time, the long-term load on the engine/generators results in increases to line 202. Line 202 can represent the initial establishment of the drilling rig, such as the building of the rig, the movement of drill pipe toward the rig, and the assembly of the various components of the drilling rig. Ultimately, line 204 shows that there are further requirements when the drilling rig begins the drilling operation. Ultimately, the power requirements will rise in the nature of line 206 during the drilling operation and the tripping of the drill pipe into and out of the well. Ultimately, after the drilling has been completed, the power requirements will diminish to level 208. As such, it can be seen from FIG. 4 that a need has developed to, in addition to the peak shaving shown in the prior art, accommodate the long term loads on the system. As such, FIG. 3 shows the system of the present invention for maximizing the use of the engine/generators so as to enhance fuel economy and to reduce emissions in relation to the long-term loads on the system.

FIG. 3 shows the power management system 210 of the present invention. As can be seen, there is a first engine/generator 212 that has output lines 214, 216 and 218 connected so as to supply power to the load 220. Load 220 can be in the nature of the loads described herein previously.

A second engine/generator 222 has output lines 224, 226 and 228 that are directed so as to supply power to the load 220. The first engine/generator 212 is synchronous with the second engine/generator 222. Each of the output lines 214, 260 and 228 will carry the various phases of the AC power from the engine/generator 212. Similarly, the output lines 224, 226 and 228 will carry the various phases from the engine/generator 222.

An AC bus 230 is connected by lines 232, 234 and 236 to the lines 238, 240 and 242 extending from the first engine/generator 212 or the second engine/generator 222. A controller 244 is electrically connected to the AC bus 230. The controller 244 is adapted to activate or deactivate at least one of the first engine/generator 212 and the second engine/generator 222 relative to the load 220. The first engine/generator 212 and the second engine/generator 222 are synchronous and will operate at a constant speed and in-phase with each other when each of the engine/generators 212 and 222 are operating.

A sensor 246 can be connected to the load 220 and to the controller 244. The sensor provides an input to the controller 244 as to the amount of the load 220. In the preferred embodiment of the present invention, the sensor 246 can sense a fuel flow rate of the load.

In the present invention, each of the first engine/generator 212 and the second engine/generator 222 as a nameplate rating. The controller 244 sets a power output to 0 to 100% of the nameplate rating. In particular, this nameplate rating has a level of maximum fuel efficiency. This level of fuel efficiency is between 0% to 100% of the nameplate rating. The controller 244 will set the first engine/generator 212 and the second engine/generator 222 at a level of maximum fuel efficiency and a desired percent of the nameplate rating. As such, the present invention is able to minimize fuel use, minimize emissions and reduce overall power requirements.

The first engine/generator 212 and the second engine/generator 222 are connected in parallel to each other on the AC bus. Circuit breakers 248 are respectively connected to lines 214, 216 and 218 extending from the first engine/generator 212. Similarly, circuit breakers 250 are connected to lines 224, 226 and 228 of the second engine/generator 222. The controller 224 is adapted to open or close the first circuit breakers 248 and the second circuit breakers 250 relative to the load 220. The controller 244 will vary a power output of the first engine/generator 212 and the second engine/generator 222 to collectively meet a demand of the load.

A third engine/generator 252 has lines 254, 256 and 258 adapted to supply AC power to the load 220 along lines 238, 240 and 242. The third engine/generator 252 is electrically connected to the AC bus 230. The controller 244 is electrically connected to the third engine/generator 252 so as to activate or deactivate the third engine/generator relative to the load. A third set of circuit breakers 260 is connected between the AC busbar 230 and the third engine/generator 252. The controller 244 is adapted open or close the set of third circuit breakers 260 relative to the load.

The system shown in FIG. 3 can also incorporate energy storage systems 262, 264, and 266. Energy storage systems 262, 264 and 266 can be in the nature of flywheels, batteries and/or capacitors. In the preferred embodiment the present invention, energy storage systems 262, 26 and 266 will be in the nature of flywheels. After experiments with the present invention, it was found that these flywheels present a relatively large power output in comparison with the power output of batteries and/or capacitors. The engine/generators 212, 222 and 252 can be in the nature of either natural gas engine/generators, dual fuel engine/generators, diesel engine/generators, flare gas engine/generators and gas turbines.

The system 210, as shown in FIG. 3, provides a process for managing power to a load. In particular, the first engine/generator 212 and second engine/generator 222 are connected to the load 220. The first engine/generator 212 and the second engine/generator 222 are synchronized together. A power demand of the load 220 is measured by sensor 246. The controller 244 will connect or disconnect one of the first engine/generator 212 and the second engine/generator 222 relative to the measured power demands of the load 220.

In this process, each of the first engine/generator 212 and the second engine/generator 222 runs at 0% to 100% of the nameplate rating. This nameplate rating has a level of optimum fuel efficiency between 0% and 100% of the nameplate rating. Each of the first engine/generator 212 and the second engine/generator 222 is run at this level of optimum fuel efficiency.

The third engine/generator 252 can be connected to the load 220. The third engine/generator 252 will be synchronous to the first engine/generator 212 and the second engine/generator 222. This third engine/generator 252 can be connected or disconnected relative to the measured power demand of the load 220. In particular, the relative circuit breaker sets 248, 250 and 260 can be opened or closed so as to connect or disconnect the engine/generators 212, 222 and 252.

The present invention is different than that of the prior art illustrated in FIGS. 1 and 2 in that it keeps the engines all synchronized together or the engines that are “online” synchronized on the AC bus. If there is no need for an engine/generator due to load conditions, then the controller 244 takes it “off-line” and shuts down the engine like any other power management system. When synchronous engine/generators are paralleled on a common AC bus, they share the load equally based on the total load of the system at that time. The load is divided equally by the number of engine/generators. As an example, if there is one megawatt of load and three-megawatt engine/generators on the line, the system of the present invention realizes this and takes at least one off-line. Therefore, only two engine/generators are online. Therefore, the original one megawatt of power, in which the three original engine/generators shared roughly 333 KW of power each, is replaced by a pair of engine/generators that supply 500 kW of power each. Ideally, the engine/generator is shut down such that the two engine/generators share the load of 500 kW with each other. Typically, the engine/generator that is shut down will be the one with the most hours on it.

Each engine/generator has a governor system. These are in the nature of electronic controls. The engines are fuel-injected and controlled by the electronic/controlled injected fuel racks. The systems are each independent for each engine and they are in a speed control/type feedback to maintain the synchronous speed in order to maintain 60 Hz or 50 Hz depending on the nominal frequency of the system. For example, rigs in the United States utilize 60 Hz and European rigs utilize 50 Hz. These engine/generators operate nominally at either 1800 RPMs or 1500 RPMs in order to maintain the 60 Hz or 50 Hz power source.

When the main circuit breakers to the engine/generator close, the engine/generator is added to the AC bus. The generator is brought up to full nominal voltage via a similar regulator, as described in FIG. 2. The voltage regulator maintains the fixed voltage output of the generator to the nominal rating of what is standard for domestic drilling rigs. In this manner, the generator is adjusting its excitation field control to maintain the nominal voltage value. For example, this nominal voltage value can be 600 VAC.

If the main circuit breaker set 248 on engine/generator 212 is closed, engine/generator 212 will now be online. As the load is demanded by the load 220, the engine speed control continuously makes fuel input to the engine that it is controlling in order to maintain the nominal frequency or speed of 1800 RPM or 60 Hz, for example. The same is true for the voltage regulator system as the load gets higher. The AC voltage drops, but the voltage regulator will see this so it injects more excitation current into the synchronous generator's field in order to maintain the voltage at its nominal value of 600 VAC. This voltage regulator is illustrated, in greater detail, in association with FIGS. 1 and 2.

When the load 220 exceeds the requirements of the first engine/generator 212 or the optimal efficiency of the first engine/generator 212, it is necessary to parallel the second engine/generator 222 to share the load with first engine/generator 212. Once the second engine/generator 222 is on-line, the voltage from the second engine/generator 220 must match in phase angle and frequency prior to closing the main circuit breaker set 250. Otherwise, the instantaneous trip of the circuit breaker set 250 so as to put the engine/generator 222 online while out of phase and out of frequency could result in a blackout condition.

Once the phase angles between the online voltage from the first engine/generator 212 and the incoming second engine/generator 222 are equal and the magnitudes are equal, only then can the controller 244 close the circuit breaker set 250 of the incoming second engine/generator 222 so as to parallel the first engine/generator 212 with the second engine/generator 222. The same relationship can occur when a third engine/generator, such as third engine/generator 252, is utilized.

The engine/generators 212 and 222 must load share. In the engine portion of the speed control, there is a feedback coming from the voltage regulator or from the controller 244 of the electrical power output of such a generator being run by the associated engine. The signal of real-time power output goes directly to the engine's electronically-controlled fuel rack or throttle system. The engine/generators 212, 222 and 252 receive those signals so as to know how much load they are sharing with their neighbor. The speed is always the same with the paralleled engine/generators 212, 222 and 252 since, as synchronous machines, they are electrically tied to one another via the main AC bus 230 in which they are paralleled and fed power. Since these are synchronous machines, zero slip occurs such that they work together in parallel. The engine speed control dictates electronically how much power each contributes.

The engine/generators 212, 222 and 252 have permanent magnet exciters on them. As such, at idle speed, there is enough voltage and energy in the permanent magnet exciter to excite the generator to full voltage or a volts per hertz function. The permanent magnet exciter is a shaft driven as part of the synchronous machine. There can be a small double power system or battery for the engine speed/regulator controls. The engine/generators 212, 222 and 252 receive its power from this until the uninterruptible power system or battery bank is charged from the mains power once power is established on the mains or within the engine/generator controls.

At this time, the engine/generators 212, 222 and 252 are synchronized and on-line. The speed will never change as to the engines since the engine/generators are all paralleled and electrically tied together via the main bus 230. The fuel is applied equally in order to share the load between the engine/generators. The fuel is supplied via the electronic fuel injection system. If any variation in the fuel requirements is required, the electronic governor will adjust the electronic fuel injection system in order to make the engine/generators share equally.

There is also an asynchronous mode of operating the paralleled engine/generators in which slip is controlled purposefully in each governor control. This slip is proportional to the given shaft load on each engine/generator. Therefore, as the engine/generator is loaded, it slips proportionately and, therefore, the other engine/generator is speed controlled but with slip compensation and will take up the load until the two engine/generators equally share the load. This control is not as accurate as responsive as modern synchronous control systems with electronic injected fuel systems. Since the engine/generators are synchronous, they do not slip. The engine controls where the load sharing occurs and creates the engine slippage. However, since they are paralleled, the load shifts without necessarily changing the system speed or frequency.

In this manner, it can be seen that by changing the fuel input via the electronic governor control, the load can be controlled by this technique or control. As load is taken off one of the engine/generators or any combination of the engine/generators, this load must then be absorbed or shifted to the other engine/generators online that are paralleled with the ones that are relinquishing the load. The load does not change, just the amount of load is adjusted on each engine/generator which the control system demands. For example, if 100% load is removed by fuel control, the engine/generator stays in parallel and just rides the changes with zero power input to the loads. If the fuel is reduced to a value which will not keep the engine at the synchronous bus frequency (i.e. engine speed), then again, since the generators are in parallel, the generator acts as a motor and motors the engine in order to keep it at synchronous speed. This is referred to as “reverse power” and protective relays properly protect this from happening by tripping the reversed power generator's main circuit breaker to get it off-line and isolated from the system. As such, it can be seen that, by controlling the governor with inputs, the present invention is able to optimize the load on each engine/generator online. As such, the emissions are reduced and fuel consumption is minimized.

The present invention provides the ability to vary the load among a currently online set of synchronized, engine/generators. The controller can operate each engine/generator differently while maintaining the load in order to optimize fuel economy and reduce emissions.

The present invention is unique in that the size of the needed energy storage system is reduced. This results in lower cost for the energy storage system. The present invention eliminates the need for specialized engine systems that maintain oil temperature and internal lubrication between startups. A commonly used engine management control is used to turn on-and-off the engine/generators as rig loads vary over the long term. The present invention provides shorter-term engine/generator control. Instead of rapidly turning engines on-and-off, the present invention favorably adjusts the load points to keep multiple engines continuously operating.

The following shows examples of methods for implementing the present invention.

Drilling rigs commonly operate four CAT 3512C diesel engine generators to meet all levels of power demand. One version of the CAT 3512C has an output of about 1100 kW at 100% load. The common approach is to run all four CAT 3512Cs which are frequency synchronized at a common speed and share the load evenly. In this example, the instantaneous rig demand load is 1250 KW. For this example, this forces each of the four CAT 3512C to operate at a load point of 28%. Referencing Graph 1 at the 28% load point the diesel generators with have both greater fuel use and emissions output (CO, HC, PM) compared to a more favorable load point range of 55% to 80%. This “sweet spot” represents a compromise between reduced emission output (NOx, CO, HC, PM) and reduced fuel use.

Tables 1 and 2 and Graphs 2 and 3 show the operating load points for the CAT 3512C diesel engine generators versus a range of rig power demand from 300 kW to 2500 kW in increments of 200 kW. These tables and figures highlight the benefit of Variable Load Control when operating up to four 3512Cs on a drilling rig.

Table 1 reflects the current practice which is to turn on diesel generators well in advance of anticipated power needs. This provides a large, conservative margin for generator power capacity. However as shown in Graph 2, operating load points are mostly well below 50% resulting in poor fuel economy and excess emissions. The average loading is 40% and ranges from 14% to 57%.

TABLE 1
Rig Power Demand vs 3512C Load Points
without Variable Load Control

| Rig Power | No. of | | | | |
|---|---|---|---|---|---|
| Demand, kWe | 3512Cs | 3512C | 3512C | 3512C | 3512C |
| 300 | 2 | 14% | 14% | | |
| 500 | 2 | 23% | 23% | | |
| 700 | 2 | 32% | 32% | | |
| 900 | 3 | 27% | 27% | 27% | |
| 1100 | 3 | 33% | 33% | 33% | |
| 1300 | 3 | 39% | 39% | 39% | |
| 1500 | 3 | 45% | 45% | 45% | |
| 1700 | 4 | 39% | 39% | 39% | 39% |
| 1900 | 4 | 43% | 43% | 43% | 43% |
| 2100 | 4 | 48% | 48% | 48% | 48% |
| 2300 | 4 | 52% | 52% | 52% | 52% |
| 2500 | 4 | 57% | 57% | 57% | 57% |

With Variable Load Control along with common load control management, the current practice to maintain a large power margin by running excessive generators is avoided. As shown in Table 2, one 3512Cs is online at full speed close to 0% load at rig demand powers of 900 kW and 2500 kW. These 3512Cs can quickly provide extra needed power to meet changing rig power demand. This approach completely replaces then need to operate excess generators at low operating load points. Most importantly, the diesel generators with Variable Load Control, as seen in Graph 3, shift the operating load point to higher values which have lower fuel consumption and emissions.

TABLE 2
Rig Power Demand vs 3512C Load Points
with Variable Load Control

| Rig Power | No. of | | | | |
|---|---|---|---|---|---|
| Demand, kWe | 3512Cs | 3512C | 3512C | 3512C | 3512C |
| 300 | 1 | 27% | | | |
| 500 | 1 | 45% | | | |
| 700 | 1 | 64% | | | |
| 900 | 1 | 82% | 0% | | |
| 1100 | 2 | 50% | 50% | | |
| 1300 | 2 | 59% | 59% | | |
| 1500 | 2 | 68% | 68% | | |
| 1700 | 3 | 52% | 52% | 52% | |
| 1900 | 3 | 58% | 58% | 58% | |
| 2100 | 3 | 64% | 64% | 64% | |
| 2300 | 3 | 70% | 70% | 70% | |
| 2500 | 3 | 76% | 76% | 76% | 0% |

For this next example of the invention, a computer simulation was completed based upon 10 days of continuous drilling for a land oil and gas rig by a major US drilling company. Power demand versus time is shown for the drilling data in Graph 4.

For this example, operating four 3512Cs with even load sharing is compared to operating a combination of 3512Cs with C18s with Variable Load Control. Whereas the 3512Cs are rated at 1100 KW, the C18 are rated at 500 kW. The C18 is a Tier Four engine. The Tier Four C18 can be operated over a wide range of load points without producing excess emissions. Top section of Table 4 shows operation with four 3512Cs. The 3512Cs are operated continuously at a low load point (40% and lower) resulting in poor efficiency. The second part of Table 4 shows rig operation with a combination of 3512Cs and C18s. This combination of generators with different rated power outputs permits Variable Load Control to operate all engine generators at their ‘sweet spot”, generally 55% to 80%, to reduce fuel use and emissions. Compared to fuel use measured by the rig operated, Variable Load Control reduces fuel use by 18%. For this example, one C18 is on standby at full speed to provide up to 500 kW of extra generator capacity, if needed. The fuel use of this C18 at its low load point is minimal as is its emission output.

For this same example, Table 5 shows the reduction in emissions using Variable Load Control. With generators of mixed power rating which then allow Variable Load Control to operate all generators at their sweet spot, emissions are reduced from 67% to 92% for HC, CO, and PM. NOx is reduced by using Variable Load Control to selectively control the Tier Four C18s.

TABLE 5
Comparison of Rig Emissions with all 3512Cs and with a 3512Cs and C18s with Variable Load Control

| | | | Average | | | | |
|---|---|---|---|---|---|---|---|
| | | Time On, | Load Point, | | | | |
| | | hours | % | NOx, LB | HC, LB | CO, LB | PM, LB |
| | Emissions Output Based Upon 10 days of Rig | | | | | | |
| | Drilling Data and using CAT's “New Engine” Test | | | | | | |
| | Data at Steady State | | | | | | |
| All CAT | C3512C: One Generator | — | — | — | — | — | — |
| 3512Cs | C3512C: Two Generators, Even Load Sharing | 1 | 13.0% | 5 | 3 | 1 | 0 |
| | C3512C: Three Generators, Even Load Sharing | 53 | 13.0% | 428 | 238 | 57 | 33 |
| | C3512C: Four Generators, Even Load Sharing | 182 | 40.0% | 4628 | 1631 | 223 | 99 |
| | Totals | 236 | | 5062 | 1873 | 280 | 132 |
| | Emissions Calculated Based Upon 10 Days of Rig | | | | | | |
| | Drilling Data, CAT “New Engine” Test Data at | | | | | | |
| | Steady State and Using Variable Load Control | | | | | | |
| Two CAT | First C18 (Tier 4) | 235.88 | 62.0% | 49 | 0 | 1 | 0 |
| C18s and | Second C18 (Tier 4) | 89.89 | 92.0% | 33 | 0 | 2 | 1 |
| Two CAT | First C3512C (Tier 2) | 146.72 | 79.0% | 2258 | 139 | 51 | 6 |
| 3512Cs | Second C3512C (Tier 2) | 119.32 | 79.0% | 1836 | 113 | 42 | 5 |
| | Totals | | | 4093 | 253 | 93 | 10 |
| | Emission Reductions with Variable Load Control | | | 19% | 87% | 67% | 92% |
| | by Boosting Generator's Operating Load Point | | | | | | |

With all the cases discussed above, at any one time, one of the fixed speed diesel generators is operated at full speed but near 0% for some period. In another embodiment of this invention and to improve the long-term health of the generator, that fixed speed generator is replaced with a variable speed engine generator. A variable speed engine generator can operate within its sweet spot in a wide range of operating load points (10% to 100%). With this approach, Variable Load Control will also provide fuel savings and emission reductions using a mix of fixed and variable speed generators.

In another embodiment of the invention, Variable Load Control is used with a combination of either 100% natural gas engine generators, 100% diesel engine generators, or both and then with dual fuel engine generators. The dual fuel engine generators are diesel engine generators which use natural gas substitution (up to 85%) to reduce diesel fuel consumption and significantly lower emissions output. However, for the dual fuel engine generators to operate more efficiently with high natural gas substitution, those engines must operate between about 50% to 85% of full rated power, or load point. By using Variable Load Control, total power output from all engine generators is achieved by separately regulating the load point of all the engine generators. The load point of the 100% natural gas engine generators and/or 100% diesel engine generators is regulated between 50% and 100% which is the range for more efficient fuel consumption. Then the dual fuel engine generators are regulated between a load point of 50% to 85% to achieve optimum fuel use efficiency concurrent with maximum natural gas substitution.

The present invention can benefit the operation of engine generators of equal power capacity. Variable Load Control is more effective at lowering fuel consumption and emission output with engine generators which have a mixed of large and mid-range power output. This invention can include both fixed speed and variable speed engine generators. The present invention will improve the efficiency of diesel, gasoline, and natural gas internal combustion engines. Variable Load Control can improve the efficiency of hybrid systems that involve combinations of internal combustion engines, battery systems, capacitor systems, and fuel cell generators. For the different power generator types, Variable Load Control adjusts each generator to its optimum operating condition while maintaining a power reserve for increases in power demand.

The present invention considers that peak shaving via an energy storage system is implemented and power management (i.e. bringing off and on) engine/generators based on long-time demand requirements is also implemented. The present invention controls the actual load of each output of the engine/generators equal to the load demand requirement while also operating the multiple engine/generators at the most efficient and lower emissions output, independent of the number of engine/generators online. This is because they are paralleled on a common AC bus.

In the present invention, the energy storage system is preferably flywheels but could include any type of capacitor systems or chemical batteries. The engine/generators include diesel engine/generators, gasoline engine/generators and natural gas engine/generators. It also can include internal combustion engines and turbines. The control of the system can be used for a variety of commercial and industrial processes, in particular, those which experience large rapidly changing demand loads. Examples include drilling rigs powered by diesel, CNG, or field gas, or combination of these. Dredging operations can also be included. The energy storage load levels the peak transient loads for these industrial processes. As such, fuel economy is improved and emissions are reduced.

As stated herein previously, rigs operate excess engine/generators to mitigate variable loads encountered during the drilling process. As an example, for the case where a rig would operate with four engine/generators continuously, with the present energy storage system, the rig can now operate for most drilling operations with two engine/generators instead of four. As drilling demand load changes, engine/generators are switched on-and-off as required. In order to maximize rig efficiency, this on-and-off switching needs to occur quickly. Ideally, the switch time is instant. In the prior art, switch-on times can last many minutes. Transitions to switch off are more rapid but result in large transients causing excess emissions (unburned fuel) and can possibly impact power quality (i.e. blackout conditions). The present invention is able to rapidly add and shed engine/generators in a manner that both avoids large engine/generator load transits which resulted in more fuel use and emissions and operating conditions with reduced engine life due to rapid starts.

The energy storage system provides supplemental power so as to permit the recently-added engine/generator to ramp up at a slow enough rate in order to avoid excess fuel use and emissions. The energy storage system then absorbs excess engine/generator power to permit the recently shed engine/generator to ramp down without the risk of excess emissions or the risk of creating power instabilities. Transition times are longer for natural gas engine/generators due to their lower nameplate power rating for step-up and step-down power changes. These require the assistance of energy storage. For energy storage systems to provide assistance with rapid switch-on and switch-off of current engine/generator controls, the stored capacity must exceed over 500 kWh for chemical battery systems. Due to the more rapid switch actions of the present invention, the need for an energy storage system capacity for a battery system is less than 50 kWh.

The current practice is to turn on diesel generators well in advance of anticipated needs. This is reflected in the data. This always provides a large, conservative margin of power capacity. However, as can be seen in the above Tables, operating load points are mostly well below 50%. This results in poor fuel economy and excess emissions. The average loading is 40% and ranges from 14% to 57%.

Flywheels are high power devices, but have lower energy capacity compared to capacitors and chemical battery systems. However, compared to capacitor and battery systems, flywheels offer lower life cycle costs, superior reliability and excellent recyclability. By using standard components common in the oil and gas industry, flywheels offer much simpler maintenance. Flywheels are particularly suited to the system of the present invention.

Studies have shown that the energy storage system benefits a drilling rig by reducing the number of continuously added engine/generators. The present invention offering variable load with continuous synchronization can further reduce the needed number of engine/generators while also reducing the size and cost of the engine storage system. In the system of the present invention, the engine/generators are continuously synchronized. The power output of each engine/generator, while being synchronized, is varied and to collectively meet (i.e. the sum of generator outputs) the instantaneous load demand of the drilling operation. The adjustable power ranges from 0% to 100% of the nameplate rating. In the system of the present invention, the transition times to add power are rapid and simply determined by maximum fuel flow rates and the desired power-time derivative. Power from one or several generators (all are synchronized) can be simultaneously added, if required. The transition time of the present invention in order to shed load is simply the desired power-time derivative.

In the system of the present invention, transition times to add or remove power is completed quickly in seconds instead of many minutes. Since the time to add power and remove power is shortened, the capacity needed from the energy storage system to provide or receive supplemental engine/generator power is greatly reduced. A major benefit of the control system of the present invention is the reduction of the size of the energy storage system for rig operations and the ability to perform rig drill operations with fewer engine/generators than with a conventional energy storage system, such as shown in the figure below. Another benefit is the unique ability to tune the synchronized engine/generators to a load set point that optimizes fuel efficiency and reduces emissions. Engine/generators typically operate most efficiently at between 40% load and 80% load. Some engine/generators produce higher emissions at loads increases beyond 80%.

The foregoing disclosure and description of the invention is illustrative and explanatory thereof. Various changes in the details of the illustrated construction can be made is the scope of the present invention without departing from the true spirit of the invention. The present invention should only be limited by the following claims and their legal equivalents.

1. A power management system comprising:
multiple engine/generators having an output line adapted to supply AC power to a load, said multiple engine/generators being synchronous, said multiple engine/generators being connected to an AC bus; and
a controller electrically connected to the AC bus, said controller adapted to activate or deactivate at least one of said multiple engine/generators relative to the load, said controller adapted to vary the load of each of said multiple engine/generators to between 0% to 100% of a power output capacity of each of said multiple engine/generators.

2. The power management system of claim 1, wherein all of said multiple engine/generators operate at a constant speed and in-phase with each other.

3. The power management system of claim 1, wherein a load point of each of said multiple engine/generators is independently variable in relation to the load.

4. The power management system of claim 1, further comprising:
a sensor connected to the load, the sensor providing an input to said controller of the amount of the load.

5. The power management system of claim 3, said sensor detecting a fuel flow rate of the load.

6. The power management system of claim 1, wherein each of said multiple engine/generators has a nameplate rating, said controller setting a power output to 0% to 100% of the nameplate rating.

7. The power management system of claim 5, wherein the nameplate rating has a level of maximum fuel efficiency which lies between 0% and 100% of the nameplate rating, said controller adjusting the multiple engine/generators to a level of maximum fuel efficiency.

8. The power management system of claim 7, wherein the nameplate rating has a level of minimum emission output which lies at 0% to 100% of the nameplate rating, said controller adjusting said multiple engine/generators to the level of minimum emission output.

9. The power management system of claim 1, wherein said multiple engine/generators are electrically connected in parallel to said AC bus.

10. The power management system of claim 1, further comprising:
a first circuit breaker connected between at least one of said multiple engine/generators and the AC bus; and
a second circuit breaker connected between another of said multiple engine/generators and said AC bus, wherein said controller is adapted to open or close the first and second circuit breakers relative to the load.

11. The power management system of claim 1, wherein said controller varies a power output of said multiple engine/generators to collectively meet a demand of the load.

12. The power management system of claim 1, further comprising:
an energy storage system connected to the load, said energy storage system adapted to supply or to store power to and from the load.

13. The power management system of claim 1, wherein each of said multiple engine/generators is selected from the group consisting of a gasoline engine/generator, natural gas engine/generator, a dual fuel engine/generator, a diesel engine/generator, a flare gas engine/generator and a gas turbine.

14. The power management system of claim 1, wherein the load is a drilling rig operation.

15. A process for managing power to a load, the process comprising:
connecting a first engine/generator and a second engine/generator to the load;
synchronizing the connected first engine/generator with the second engine/generator to full speed;
measuring a power demand of the load;
controlling the synchronized connected first engine/generator and the second engine/generator where an output of each first engine/generator and second engine/generator is independently controlled between 0% and 100% of a nameplate power rating thereof such the combine power of the first engine/generator and the second engine/generator meets a load demand; and
connecting or disconnecting at least one of the first engine/generator and the second engine/generator relative to the measured power demand of the load.

16. The process of claim 15, wherein each of the first engine/generator and the second engine/generator has a level of optimum fuel efficiency and at a minimum level of emissions output between 0% to 100% of the nameplate rating, the step of running comprising:
running each of the first engine/generator and the second engine/generator at the level of optimum fuel efficiency and minimum emissions output.

17. The process of claim 15, further comprising:
connecting or disconnecting at least one of the first engine/generator and the second engine/generator relative to the measured power demand of the load.

18. The process of claim 15, wherein the step of connecting or disconnecting comprises:
opening or closing a circuit breaker on a line between an AC bus and each of the first engine/generator and the second engine/generator.

20. The process of claim 15, wherein the load is a drilling operation.
